(19) United States
(12) Patent Application Publication
(10) Pub. No.: US 2010/0108615 A1
(43) Pub. Date: May 6, 2010

(54) METHOD AND AN APPARATUS FOR TREATMENT OF A SUBSTANCE HAVING ORGANIC CONTENT

(76) Inventors: Carsten Christophersen, Struer (DK); Erik Jessen Jürgensen, Rude (DK)

Correspondence Address: KNOBBE MARTENS OLSON & BEAR LLP, 2040 MAIN STREET, FOURTEENTH FLOOR, IRVINE, CA, 92614, US

(21) Appl. No.: 12/438,925

(22) PCT Filed: Sep. 4, 2007
(86) PCT No.: PCT/DK07/50123

§ 371 Date: Oct. 8, 2009

(30) Foreign Application Priority Data
Sep. 4, 2006 (DK) PA2006 01138

(51) Int. Cl. C02F 1/72; C02F 1/24

(52) U.S. Cl. 210/704; 210/199

(57) ABSTRACT

The present invention relates to a method for treatment of substance having a content of organic material, e.g. manure from stables (1). The substance is initially separated into a first liquid phase and a first sludge phase, and an oxidation is performed, preferably by ozone, on at least one of the phases of the substance. From the first sedimentation process or flotation process the first sludge phase is separated, and a second sedimentation or flotation process is performed on the first liquid phase, preferably by addition of a polymer, and from the second sedimentation process or flotation process a second liquid phase is passed on to a further separation process, in which separation process a further oxidation, preferably by ozone, is performed on the second liquid phase. Preferably, the ozonation is substantially saturated. An important advantage is that malodour from the substance may be significantly reduced, possibly even eliminated.

### FIELD OF THE INVENTION

The present invention relates to treatment of a substance having an organic content, e.g. waste such as manure from livestock farms such as farms for pigs, cattle, poultry or other livestock, or such as effluent waste from households such as kitchen or toilet sewage or from industry such as effluent water from the food processing industry.

### BACKGROUND OF THE INVENTION

U.S. Pat. No. 4,790,943 discloses a process for treating effluent water of a poultry processing plant for reuse in that plant. Treatment is performed of the effluent with a strong oxidant and with a substance to reduce the pH to less than 5.2 pH units, and preferably about 3.0+/−0.5 pH units, and causes a flock to form together with a destruction of bacteria and a breaking of the oils and greases. The flock contains the impurities so that the water separated from the flock is sufficiently purified for reuse in certain processing steps in the plant. In the case of treating effluent water from the poultry chiller tank(s), the product water can be reused in the tank(s). Formation of the flock may be enhanced by the addition of an anionic polymer, and separation is achieved by dissolved air flotation techniques. A final filtration can be utilized after a readjustment of the pH to near neutral to match new water to be used in the plant.

### SUMMARY OF THE INVENTION

It is an object of the present invention to provide a method and an apparatus which is capable of treating a substance including an organic material into different constituents by the use of few method steps to reduce the amount of malodour from the barn area and from exterior environment.

It may also be seen as an object of the invention to use cost effective additives and to do so by an apparatus which is cost efficient to manufacture, to establish and to operate. It may also increase the well-being of the personnel working in the stables/barns and may also increase the well-being of the livestock. Increased well-being of the livestock may result in faster growth of the livestock and reduced risk of infections. It may also be seen as an object of the invention to disinfect manure from livestock.

These and other objects may be obtained by a method for treatment of substance having a content of organic material, by which method the substance is initially separated into a first liquid phase and a first sludge phase, and where an oxidation is performed on at least one of the phases of the substance, and where said first liquid phase of the substance forms part of a first sedimentation or flotation process, at which first sedimentation process or flotation process a division of the substance into the first sludge phase and the first liquid phase takes place, and from which first sedimentation process or flotation process the first sludge phase is separated, and a second sedimentation or flotation process is performed on the first liquid phase, and from said second sedimentation process or flotation process a second liquid phase is passed on to a further separation process, in which separation process a further oxidation is performed on the second liquid phase.

The invention is particularly, but not exclusively, advantageous for obtaining useful fractions of e.g. manure from livestock. In particular, the manure may be enriched by a special or dedicated animal feed given to the livestock, e.g. pigs. Alternatively or additionally, the manure may be enriched due to genetic engineering performed on the livestock, e.g. pigs having genes inserted that result in enriched manure comprising pharmaceutically active substances worth extracting from the manure.

In particular, the substance treated by the present invention may result in one or more liquid phases and one or more sludge phases that are easier to handle from an economic perspective and/or an environmental view point.

An important advantage of the present invention originates from the fact that malodour from the substance having an organic content may be significantly reduced, possibly even eliminated. More specifically, the substance may be separated into fractions where only one or two fractions have a malodour, thus reducing the problem of malodour. The separation of the substance into several different phases also may facilitate easier handling of the substance.

Another advantage of the present invention may be that the substance, after being treated by a method according to the invention, is substantially free from bacteria, i.e. sterile. This significantly reduces environmental and/or safety hazards from the substances. In some embodiments, the substance has a reduced level of bacteria after having been treated by a method according to the invention.

In some embodiment, the oxidation may be performed on at least one of the phases of the substance, and/or the further oxidation performed on the second liquid, is performed by ozone or another oxidising agent with a higher redox potential. This can result in relatively efficient oxidation. Alternatively, an oxidizing agent with a lower redox potential can be used, e.g. hydrogen peroxide. Possibly, the oxidation can be assisted by one or more electrochemical electrodes.

In a preferred embodiment, the first and/or the second flotation process may be performed by adding a flotation agent, the agent preferably being a polymer, as will be described in more detail below. Possibly, the first and/or the second flotation process may be assisted by one or more electrochemical electrodes.

Possibly, the first and/or the second sedimentation process may involve a mechanical separation of some kind. Thus, some mechanical separation means may be: swirl separator, screw pressure device, a conveyor filter, and centrifugal means, but other separation means are readily available.

In some embodiments, the further separation process may comprise a third sedimentation or flotation process.

For optimising the method, any of the method steps may be performed more than once i.e. repeated as required. This can be done via recirculation and/or more addition of active agent i.e. ozone or polymer.

Preferably, any of the method steps may comprise an acidification of the substance. Thus, an acid like H₂SO₄ or other suitable acids, cf. below, can be added. Possibly, bases can be used for adjusting the pH level during treatment of the substance.

For optimising the method, any of the method steps may be controlled with a feedback mechanism regulated by at least one of the parameters: an optical transmission of the substance, an optical colour of the substance, level of pH, a level of oxidation agent (preferably ozone (O₃)), and a level of hydrogen sulphide (H₂S). Possibly, single species in the substance may be monitored for controlling the process.

In some embodiments, the substance may be manure from livestock excrements or effluent substance from animal husbandry. Alternatively, the substance may be effluent such as effluent from households, aquaculture, hotels, industry (including fishing industry), or medical care institutions.

Preferably, the first and/or the second and/or the third flotation process may include addition of oxygen and/or oxygen with ozone to be dissolved in the substance during the flotation process, preferably by addition of bubbles comprising oxygen, more preferably micro-bubbles comprising oxygen.

More preferably, the oxidation may be performed by adding ozone (O₃) at an under-pressure formed within the phase to be oxidised, said under-pressure being of a sufficient magnitude so that the ozone is sucked into the phase.

The object of the invention may also be obtained by an apparatus for treatment of substance having a content of organic material, said apparatus comprising at least one of each of the following substance vessels: a vessel arranged for adding an oxidant to at least one phase of the substance, a vessel arranged for adding an acid to a liquid phase of the substance and a vessel arranged for adding micro-bubbles to the liquid phase of the substance.

Possibly, the apparatus may furthermore comprise at least one vessel for adding a polymer to the liquid phase of the substance. The apparatus may have an inlet constituted by one or more Venturi for inserting at least the oxidant, possibly also the polymer, to at least one of the phases of the substance.

Preferably, the apparatus also comprises an inlet for the polymer, possibly together with an inlet constituted by one or more Venturi for inserting the oxidant to at least one of the phases of the substance. The apparatus may comprise a compressor-free pump for pumping dissolved gas for forming the micro-bubbles, and where at least one vessel is provided for adding the micro-bubbles to the liquid phase.

In some embodiments the vessel for adding the polymer to the liquid phase may be provided subsequent to the vessel for adding acid, i.e. subsequent in relation to the process flow direction through the apparatus.

In some embodiments the vessel for adding the micro-bubbles to the liquid phase may be provided subsequent to the vessel for adding the acid, i.e. subsequent in relation to the process flow direction through the apparatus.

In some embodiments the vessel for adding the micro-bubbles to the liquid phase is provided subsequent to the vessel for adding the polymer, i.e. subsequent in relation to the process flow direction through the apparatus.

Preferably, the oxidant may be a gas, preferably ozone, and the apparatus may be arranged for creating an under-pressure in a liquid phase sucking the gas into the substance. The under-pressure may created by so-called “cavitation” of a pump. Preferably, the apparatus may comprise an inlet pipe for guiding the gas into the substance.

Advantageously, the apparatus may be positioned in a substantially air-tight tank so as to reduce evaporation and/or confine malodour. Additionally, the apparatus may be arranged for collecting, and optionally processing, gasses from the substances as these gases may be useable for other purposes.

The first and second aspect of the present invention may each be combined with the other aspect. These and other aspects of the invention will be apparent from and elucidated with reference to the embodiments described hereinafter.

### BRIEF DESCRIPTION OF THE DRAWINGS

The present invention will now be explained, by way of example only, with reference to the accompanying Figures, where

FIG. 1 is a schematic drawing showing an embodiment of an apparatus according to the invention for treatment of a substantially liquid phase of manure from livestock, and

FIG. 2 is a drawing of an embodiment of the apparatus in different sectional views.

### DETAILED DESCRIPTION OF AN EMBODIMENT OF THE INVENTION

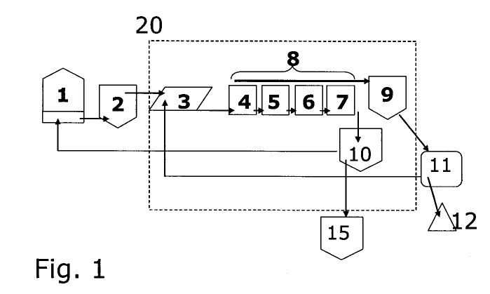

FIG. 1 is a sketch showing an apparatus 20 divided into different elements for treatment of manure. In the embodiment shown, the apparatus may be positioned in a 20 feet or 40 feet standard sized container divided into vessels, each for different steps of the substance treatment method according to the invention. In the process steps shown, the substance is manure from livestock, though this embodiment is only one specific example for application of the present invention, this embodiment being by no means limiting for other applications of the invention.

The apparatus 20 being a standard sized container makes the apparatus easy to handle seeing that standardised transportation by truck and/or by ship may be employed when transporting the apparatus from a manufacturing site to a site of operation.

Manure from a livestock stable 1 or other accommodation for livestock is led to a tank 2, preferably the transport from the stable 1 to the tank 2 is performed substantially by the action of gravity in order to not disintegrate or break up organic lumps, i.e. faeces, into smaller lumps. The tank 2 makes it possible to quickly empty the stable 1 from manure should the need arise. Some decomposition may occur during this transportation, and measures may be taken to avoid anaerobic conditions that will result in e.g. hydrogen sulphide and methane. Possibly ozone can be added to avoid that grease and other organic depositions can take place in the pipes from the stable 1 to the tank 2.

In the tank 2, some sedimentation will take place, and from the tank 2 the manure can be conducted on to the filter 3. The manure can be taken from a certain height in the tank 2 whereby any sedimented material can remain in the tank 2. Ozone may be added to the tank 2, preferably at a periphery of the tank 2, in order to keep the tank aerobic and thereby substantially free from malodour.

A first step comprises treatment of the manure for dividing the manure into a liquid phase and a solid phase. Dividing the manure into a liquid phase and a solid phase is preferably accomplished by employing a filter 3. Alternative equipment for dividing or roughly separating the manure into the liquid phase and the solid phase includes a screw press, a whirl separator or other suitable means for dividing the manure into a more or less solid phase and a more or less liquid phase before further treatment is effected.

After the first rough division of the manure, the substantially liquid phase is pumped to a first vessel 4 within the standardized container. In the first vessel 4, an oxidant is added to the liquid phase of the manure, preferably there is added ozone (O₃). Adding of an oxidant such as ozone has the effect of breaking down any emulsions present in the liquid phase of the manure. As it is well-known in the literature, ozone has a number of direct and indirect chemical reactions with organic compounds. Oxidants other than ozone may be used, preferably having an oxidation potential equal to or higher than the oxidation potential of ozone which is 2.07 V. Alternatively, hydroxyradical (OH) with a redox potential of 2.86 V may be formed (for example from ozone) and applied. In particular, hydrogen peroxide (H₂O₂) at an even lower redox potential of 1.78 V may be applied. It is also contemplated that hydrogen peroxide in combination with ultra violet (UV) light may create highly oxidising radicals that may beneficially be applied. Ultra violet light may be provided by inserting UV lamps into one or more of the vessels 4-7. UV lamps may also be combined with the use of ozone as oxidising agent. The three aforementioned oxidants: ozone, hydroxyradical, and hydrogen peroxide, have the advantage that they are biologically degradable unlike most oxidants containing metals.

The applicant has performed tests demonstrating that when oxidizing with ozone it is advantageous to have a high degree of ozonation i.e. that the manure in the first vessel 4 is substantially saturated with ozone (alternatively oxygen). Ozonation can be defined as a liquid treatment process that destroys bacteria and other microorganisms by ozone. It is observed that this can be confirmed visually, in particularly by observing the foam development on the top. For a manure throughput of about 50 m³/h this can be obtained by about 500 g/h ozone in the first vessel 4. For operation with ozone oxidation in more than one vessel, the ozone consumption may be as high a five times bigger in the first vessel 4 compared to the other vessel.

In a specific embodiment, the oxidation is performed or assisted by electrochemical electrodes installed in one or more of the vessels 4-7. Preferably, the electrodes should be capable of withstanding the harsh environment in the vessels. Electrodes such as diamond electrodes can be applied. In particular, the electrodes may generate ozone within the liquid phase to be treated.

When an oxidant is added, foam is formed on top of the liquid phase of the manure. The foam is skimmed off by a foam screw (not shown in the Figure but indicated by an arrow over the vessels) or other transportation means capable of removing the foam from the top of the liquid manure in the first vessel 4.

After having been treated by an oxidant in the first vessel 4, the liquid phase of the manure is led to a second vessel 5. In the second vessel 5, a polymer is added to the liquid phase of the manure. Adding of a polymer such as a cationic polymer has the effect of increasing separation of suspended solids and carbon compounds from the liquid phase of the manure. With the polymer, small particles in the liquid phase are agglomerated into large particles or flocks.

The polymer is preferably a cationic polymer. However, the choice of polymer depends on the electric charge of the ions in the liquid phase of the manure. The choice of polymer is preferably oppositely electrically charged relative to the main parts of ions in the liquid phase of the manure. Thus, depending on the manure, or more generally the substance with organic content, the polymer may also be an anionic polymer.

When a polymer is added, foam is formed on top of the liquid phase of the manure. The foam is skimmed off by the foam screw (not shown) or other transportation means capable of removing the foam from the top of the liquid manure in the second vessel 5.

The technical purpose of adding the polymer is to bind the maximum amount of particle material so that the content of suspended particles in the manure is minimized. The polymer is preferably added through a pump (on the soaking side), and it should be added in a sufficient amount so as to exploit the entire vessel 5. The consistency of the foam may be used as an indication of the correctness of the added amount of polymer.

After having been treated by a polymer in the second vessel 5, the liquid phase of the manure is led to a third vessel 6. In the third vessel 6, an acid is added to the liquid phase of the manure, preferably sulphuric acid (H₂SO₄), nitric acid (HNO₃), acetic acid (CH₃COOH) is added. In a particular preferred embodiment, the acid added is biodegradable so that the introduction of the acid does not result in any negative influence on the surrounding environment. Adding sufficient acid such as the preferred sulphuric acid has the effect of reducing the pH level of the liquid phase of the manure, thus bringing the ammonia (NH₃) into the corresponding acid-form; ammonium (NH₄⁺). Typically, that will reduce the malodour of the liquid phase by lowering the ammonia evaporation.

Other acids, such as nitric acid, hydrochloric acid, etc. may also be used. Use of a strong acid reduces the quantity of acid required to achieve a desired pH level. When acid is added, foam may also be formed on top of the liquid phase of the manure. The foam is then skimmed off by the foam screw or other transportation means capable of removing the foam from the top of the liquid manure in the third vessel 6. In some embodiments, a base may alternatively be applied to adjust the pH level in the third vessel 6.

The combined action of acid and oxidant breaks down fat, grease and other organic emulsions present in the liquid phase and creates sludge of the impurities. At the same time, anaerobic bacteria in the waste water are substantially destroyed, and the risk of malodour, such as malodour from ammonia (NH₃) and hydrogen sulphide (H₂S), is reduced.

After having been treated by an acid in the third vessel 6, the liquid phase of the manure is led to a fourth vessel 7. In the fourth vessel 7, micro-bubbles of ozone (O₃) or of atmospheric air or of a combination of ozone and atmospheric air are added to the liquid phase of the manure. Micro-bubbles may be made by dissolving the gas under overpressure and subsequently lower the pressure to e.g. atmospheric pressure so as to release the dissolved gas in the liquid as micro-bubbles. The micro-bubbles create bubbles containing oxygen throughout the entire vessel. Micro-bubbles may be defined as bubbles having a maximum diameter of 100 micro-meters, preferably 50 micro-meters, or more preferably 30 micro-meters. The purpose of using micro-bubbles is to increase the surface-to-volume ratio making the available amount of oxidising oxygen/ozone significantly higher as compared to bigger bubbles.

Addition of micro-bubbles of ozone and/or atmospheric air has the effect of supplying an adequate amount of oxygen to enhance microbial activity in relation to available carbon and nitrogen in the liquid phase of the manure. When micro-bubbles are added, foam is also formed on top of the liquid phase of the manure. The foam is skimmed off by the foam screw or other transportation means capable of removing the foam from the top of the liquid manure in the fourth vessel.

After having been treated by micro-bubbles in the fourth vessel 7, the liquid phase of the manure is fully treated, and the fully treated liquid phase of the manure is passed to a pump for further waste management or returned to the livestock stable 1.

In a process alternative to the process shown above, oxidant such as ozone may be added to more vessels than the first vessel 4. Thus, oxidant may be added to at least one vessel other than the first 4, i.e. to one or more of the second 5, the third 6 and the fourth 7 vessel. The number of vessels may also be altered depending on the specific parameters and the specific technical results to be obtained by the process.

In a process alternative to the process shown above, polymer may be added to more vessels than the second vessel 5. Thus, a suitable polymer may be added to at least one other vessel than the second 5, i.e. to one or more of the first 4, the third 6 and the fourth 7 vessel. In particular, the applicant has performed preliminary tests indicating that the combination of substantially complete ozonation and a polymer addition (either simultaneously or consecutively) in the first vessel 4 and second vessel 5, respectively, can surprisingly quickly treat the manure in a beneficial manner. Results indicate that flotation of the manure in the second vessel 5 occur almost immediately i.e. within 60 seconds, preferably within 40 seconds, or more preferably within 20 seconds.

In a process alternative to the process shown above, acid may be added to more vessels than the third vessel 6. Thus, an acid may be added to at least one other vessel than the third 6, i.e. to one or more of the first 4, the second 5, and the fourth 7 vessel.

The process is preferably an ongoing process, which may take place in one or more vessels. Depending on the type of waste and/or the desired output of the process, one or more process steps may be repeated one or more times in any of the vessels 4, 5, 6, and/or 7. The production of oxidant or the means for adding the oxidant may take place centrally from one unit to all the vessels where oxidant is to be added.

Sensors may be provided at each method step where oxidant is capable of being added, and a feedback system may control the addition of oxidant to each one of the method steps in question.

The oxidant, when being added, is preferably added to a periphery of the first 4 and possibly further vessels where the oxidant is added. By adding the oxidant along the periphery of the first and possible more vessels, the contents of the vessel is maintained aerobe and thus maintained substantially odourless.

The oxidant such as ozone is preferably added to at least the first vessel through one or more inlets constituted by Venturi. By adding the oxidant such as ozone through a Venturi, the need for pressurising the oxidant such as ozone may be eliminated. Also the polymer is preferably added through Venturi. A flow of liquid phase of the manure may be divided into two pipes, each pipe being provided with Venturi, one pipe for adding the oxidant such as ozone, and the other pipe for adding the polymer.

Depending on the oxidant used, the oxidant may be hazardous to human beings or the livestock, and adequate safety measures and means should be implemented.

The foam having been skimmed off the vessels 4-7 is passed on to tank 9 as indicated by the arrow over the vessels. Skimming of the foam may, as described, take place by a screw conveyer. Alternatively, a band conveyer may be used. The conveyor used may either be provided just in the top surface of the liquid phase, or the conveyer may be provided extending along a different upwards sloping angle. The latter embodiment may be an advantage, if and when the vessels are not fully filled by the liquid phase of the manure. This foam may be processed through a mechanical separator such as screw press or similar means capable of separating the foam into a liquid phase and a substantially solid phase, i.e. dry matter, the dry matter being indicated by triangle 12.

Contained within a further standardized container, apart from the vessels, gas generators for generating ozone at site are also contained, a pump for forming the micro-bubbles is also contained and other equipment for operating the apparatus is also contained. Thereby, the apparatus may be operated as a stand-alone plant.

During operation of the apparatus 20, the apparatus is arranged for collecting evaporated gasses from the substance as indicated by bracket 8, so-called “stripping” of ammonia for example by controlling the pH-level in the vessels. Optionally, the apparatus may be arranged for processing of the collected gasses at least compressing and storing the collected gasses. Additionally, the apparatus is positioned in a substantially air-tight tank so as to reduce evaporation and/or confine malodour. The tank may be a standard size 20 feet or 40 feet container. Evaporated ammonia (NH₃) may be removed or reduced by filtered the gas through an acid solution that binds the ammonia.

From the liquid phase collection vessel 10, the treated liquid phase of the manure may be further handled, e.g. sent back into the stable/barn 1, and/or treated depending on the intended use of the treated liquid phase, possibly re-treated in the apparatus as indicated by the arrow back to the separation filter 3. Typically, the treated liquid is sent to the external tank 15 and/or returned to the stable/barn 1. Possibly, the liquid phase may be spread on ground for direct utilisation of the dissolved nutritious constituents of the treated liquid phase. Alternatively, the treated liquid phase may be further processed to divide the treated liquid phase into water and concentrated nutritious constituents.

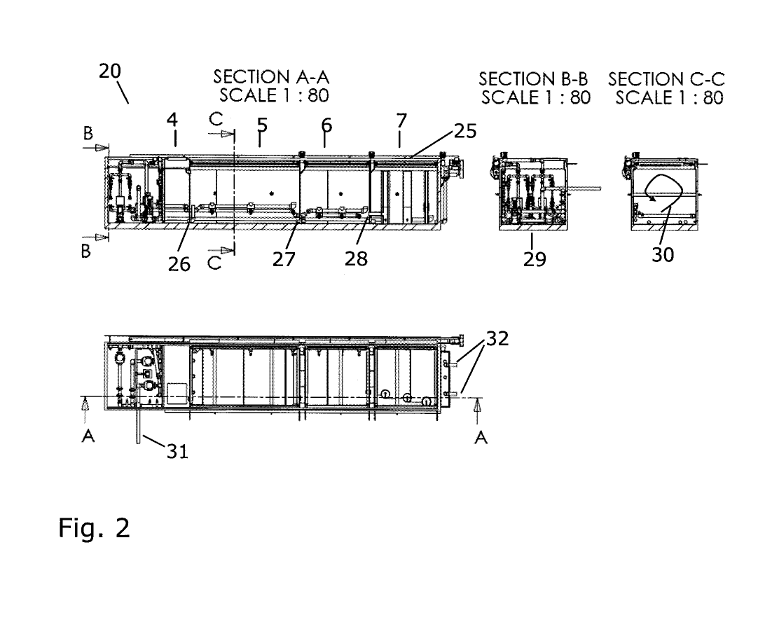

FIG. 2 is a drawing of an embodiment of the apparatus 20 in four different sectional views. The four vessels are again indicated by 4, 5, 6, and 7. The apparatus shown can be placed in a 40 feet standard container and has a capacity suitable for many typical farm applications. The apparatus 20 shown in FIG. 2 performs separation by flotation in the vessels 4-7 resulting in foam on the surface of the liquid, which is removed by a foam screw 25. The foam screw 25 is height adjustable so that the screw is correctly positioned near the surface level of the liquid in the vessels 4-7. The vessels are interconnected by connecting pipes or holes 26, 27, 29, and normally these pipes or holes are left open, i.e. the apparatus 20 is operated in a continuous mode, the vessels thereby being so-called communicating vessels. Alternatively, a batch mode of operation can be applied.

In section B-B, pumps and other equipment for operating the apparatus 20 are displayed. The various pumps for the different vessels may be connected with ozone generators and addition means for polymers and acids. Also the degree of recirculation to and from the vessels 4-7 can be controlled. As indicated in section C-C by the circular arrow 30, the stirring in the vessels 4-7 can also be controlled. In the lower view, the intake of manure 31 and outputs 32 are indicated.

During practical implementation on e.g. a farm, the apparatus can handle an in-flow of manure in the range from: 0.5 m³/h-60 m³/h, preferably 1 m³/h-40 m³/h, or more preferably 1½ m³/h-20 m³/h. Typically, there will a certain degree of recirculation of the treated manure through the apparatus. Thus the apparatus should preferably have a relatively high capacity in order to provide for recirculation and/or peak loading. Once the general principle of the invention is appreciated, the up-scaling or down-scaling of the apparatus to other applications is not expected to pose any problems to a person skilled in waste management.

In the above description, the invention is described with reference to manure as the waste to be treated, and with reference to a plant situated at a stable for livestock. In other embodiments of the invention, both the method according to the invention, the apparatus according to the invention and the plant according to the invention may instead be used for household waste or may in stead be used for industry waste such as effluent water from the food processing industry. In relation to treatment of waste from animal husbandry, the waste is not limited to manure from excrements from the animals, but may e.g. also be effluent water from the animal husbandry when cleaning stables or otherwise forming waste water or other kind of waste, which may be treated according to the invention.

According to the present invention, the method steps, the apparatus and the plant are thus incorporated by reference in relation to other uses such as the ones mentioned above, and to uses where the invention is technically applicable.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for treatment of substance having a content of organic material, by which method the substance is initially separated into a first liquid phase and a first sludge phase, and where an oxidation is performed on the first liquid phase of the substance by adding an oxidant, and said first liquid phase of the substance forms part of a first sedimentation or flotation process, where the first flotation process is performed by adding a flotation agent, the agent being a polymer, at which first sedimentation process or flotation process a division of the substance into the first sludge phase and the first liquid phase takes place, and from which first sedimentation process or flotation process the first sludge phase is separated, and a second sedimentation or flotation process is performed on the first liquid phase, and from said second sedimentation process or flotation process a second liquid phase is passed on to a further separation process, in which separation process a further oxidation is performed on the second liquid phase.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. The method according to claim 1, where the further oxidation performed on the second liquid is performed by ozone or another oxidising agent with a high redox potential.

28. The method according to claim 1, where the oxidation performed on at least one of the phases of the substance or the further oxidation performed on the second liquid is performed by assistance by one or more electrochemical electrodes.

29. The method according to claim 1, where the second flotation process is performed by adding a flotation agent.

30. The method according to claim 1, wherein the first or the second flotation process is assisted by one or more electrochemical electrodes.

31. The method according to claim 1, where the first or the second sedimentation process involves a mechanical separation.

32. The method according to claim 1, where the further separation process comprises a third sedimentation process or a flotation process.

33. The method according to claim 1, where the oxidation performed on the first liquid is performed by ozone or another oxidising agent with an oxidation potential equal to or higher than the oxidation potential of ozone.

34. The method according to claim 1, where the method steps are controlled with a feedback mechanism regulated by at least one of the parameters: an optical transmission of the substance, an optical colour of the substance, level of pH, a level of oxidation agent (preferably ozone (O₃)), and a level of hydrogen sulphide (H₂S).

35. The method according to claim 1, where the substance is manure from livestock excrements or effluent substance from animal husbandry.

36. The method according to claim 1, where the first or the second or the third flotation process includes addition of oxygen or oxygen with ozone to be dissolved in the substance during the said flotation process, preferably by addition of bubbles comprising oxygen, or micro-bubbles comprising oxygen or oxygen with ozone.

37. The method according to claim 27, where the oxidation is performed by adding ozone (O₃) at an under-pressure formed within the phase to be oxidised, said under-pressure being of a sufficient magnitude so that the ozone is sucked into the phase

38. An apparatus for treatment of substance having a content of organic material, said apparatus comprising at least one of each of the following substance vessels: a vessel arranged for adding an oxidant to at least one phase of the substance, the oxidant being ozone, and a vessel arranged for adding an acid to a liquid phase of the substance and a vessel arranged for adding micro-bubbles to the liquid phase of the substance, where the apparatus furthermore comprises at least one vessel for adding a polymer to the liquid phase of the substance.

39. The apparatus according to claim 38, where an inlet for at least the oxidant, possibly also the polymer, to at least one of the phases of the substance is constituted by one or more Venturi.

40. The apparatus according to claim 38, where an inlet for the polymer, possibly together with an inlet for the oxidant, to at least one of the phases of the substance is constituted by one or more Venturi.

41. The apparatus according to claim 38, where a compressor-free pump for pumping dissolved gas is provided for forming the micro-bubbles, and where at least one vessel is provided for adding the micro-bubbles to the liquid phase.

42. The apparatus according to claim 38, where the vessel for adding the polymer to the liquid phase is provided subsequent to the vessel for adding acid.

43. The apparatus according to claim 38, where the vessel for adding the micro-bubbles to the liquid phase is provided subsequent to the vessel for adding the acid

44. The apparatus according to claim 38, where the vessel for adding the micro-bubbles to the liquid phase is provided subsequent to the vessel for adding the polymer.

45. The apparatus according to claim 38, where the oxidant is a gas, and the apparatus is arranged for creating an under-pressure in a liquid phase sucking the gas into the substance.
